(19) United States
(12) Patent Application Publication
(10) Pub. No.: US 2020/0383161 A1
(43) Pub. Date: Dec. 3, 2020

(54) ACCESS CONTROL METHOD AND DEVICE, AND COMPUTER STORAGE MEDIUM

(71) Applicant: GUANGDONG OPPO MOBILE TELECOMMUNICATIONS CORP., LTD., Dongguan (CN)

(72) Inventor: HAI TANG, Dongguan (CN)

(21) Appl. No.: 16/988,339

(22) Filed: Aug. 7, 2020

Related U.S. Application Data
(63) Continuation of application No. PCT/CN2018/080546, filed on Mar. 26, 2018.

(51) Int. Cl. H04W 76/18

(52) U.S. Cl. CPC H04W 76/18

(57) ABSTRACT

Provided are an access control barring method and device, and a computer storage medium. The method includes that: an access stratum (AS) notifies a non-access stratum (NAS) of an access attempt triggered by the AS; the NAS stratum determines an access category corresponding to the access attempt, and assigns a cause value corresponding to the access attempt; and the NAS stratum notifies the AS stratum of the access category and the cause value corresponding to the access attempt.

### CROSS-REFERENCE TO RELATED APPLICATION

This application is a continuation of international application No. PCT/CN2018/080546, filed on Mar. 26, 2018, the content of which is herein incorporated by reference in its entirety.

### BACKGROUND

As a fundamental function of a Long Term Evolution (LTE) system and a 5th Generation (5G) system, access control barring (ACB) is mainly to control, according to load of a network, the number and frequency of connections initiated by a terminal, thus preventing overload of the network.

### SUMMARY

The disclosure relates to the technical field of wireless communications, and in particular to a method and device for access control barring, and a computer storage medium.

A method for access control barring provided by the embodiments of the disclosure includes that:

an AS stratum notifies an NAS stratum of an access attempt triggered by the AS;

the NAS stratum determines an access category corresponding to the access attempt, and assigns a cause value corresponding to the access attempt; and

the NAS stratum notifies the AS stratum of the access category corresponding to the access attempt and the cause value corresponding to the access attempt.

A method for access control barring provided by the embodiments of the disclosure includes that:

an AS stratum obtains an access attempt triggered by the AS; and

the AS stratum determines an access category corresponding to the access attempt and a cause value.

A device for access control barring provided by the embodiments of the disclosure includes: a report unit, a determination unit and a notification unit.

The report unit is configured to notify, via an AS stratum, an NAS stratum of an access attempt triggered by the AS.

The determination unit is configured to determine, via the NAS stratum, an access category corresponding to the access attempt, and assign a cause value corresponding to the access attempt.

The notification unit is configured to notify, via the NAS stratum, the AS stratum of the access category corresponding to the access attempt and the cause value corresponding to the access attempt.

A device for access control barring provided by the embodiments of the disclosure includes an obtaining unit and a determination unit.

The obtaining unit is configured to obtain, via an AS stratum, an access attempt triggered by the AS.

The determination unit is configured to determine, via the AS stratum, an access category corresponding to the access attempt and a cause value.

In the embodiment of the disclosure, in a case of extending a length of MSG3, the determination unit is configured to determine, via the AS stratum, a first access category corresponding to the access attempt, and determine a first cause value corresponding to the first access category, the first cause value being a newly established cause value based on the first access category.

A computer storage medium provided by the embodiments of the disclosure has computer executable instructions stored thereon. The computer executable instructions may be executed by a processor to implement the above-mentioned methods.

### BRIEF DESCRIPTION OF THE DRAWINGS

The accompanying drawings are described here to provide a further understanding of the disclosure, and form a part of the disclosure. The schematic embodiments and description of the disclosure are adopted to explain the disclosure, and do not form improper limits to the disclosure. In the drawings:

FIG. 1 is a first schematic flowchart of an ACB method according to embodiments of the disclosure.

FIG. 2 is a second schematic flowchart of an ACB method according to embodiments of the disclosure.

FIG. 3 is a first structural schematic diagram of an ACB device according to embodiments of the disclosure.

FIG. 4 is a second structural schematic diagram of an ACB device according to embodiments of the disclosure.

FIG. 5 is a structural schematic diagram of a computer device according to embodiments of the disclosure.

### DETAILED DESCRIPTION

In a 5G new radio (NR) system and an enhanced long term evolution (eLTE) system, an access attempt triggered by an access stratum (AS) is needed to be subjected to the ACB. A concept of unified access control (UAC) has been introduced to the 5G NR. The UAC is originally adopted to make all solutions of the NR applicable to the eLTE, that is, the UAC is uniform for all eLTE air interfaces and NR air interfaces using a 5G core network. However, according to the UAC solution, the length of message 3 (MSG3) needs to be extended because the eLTE still has an LTE protocol below a packet data convergence protocol (PDCP) stratum. Extending the size of the MSG3 may result in incompatibility, so it is hard to extend the length of the MSG3.

It is agreed in the 3rd generation partnership project (3GPP) that an establishment cause value for the UAC needs to be not smaller than 8, or even reaches 16. Nevertheless, 7 cause values have been taken up in the existing LTE MSG3 (such as an RRC connection request). It is apparently insufficient for the LTE MSG3 to carry an establishment cause of the UAC.

Unlike the LTE, an access category mechanism of the LTE only gives a consideration to signaling triggered by a non-access-stratum (NAS). Whereas, signaling triggered by the AS in the 5G NR, such as RAN area update, is also needed to be subjected to ACB. In addition to the RAN area update, UAC mechanisms of the 5G and the eLTE can further support the ACB for signaling generated by a connected terminal, such as the ACB for establishment and modification signaling of a protocol data unit (PDU) session initiated by a connected user equipment (UE), and support the ACB that may be performed by the connected UE on a user plane for different QoS flows. The ACB triggered by the AS is a problem to be solved by the NR and the eLTE.

It is difficult to extend MSG3 in the eLTE. There is need to propose how to support ACB of a new access attempt triggered by the AS.

ACB is performed based on an access category and an establishment cause provided by an NAS stratum in the present mechanism. However, ACB of an access attempt triggered by an AS cannot be implemented because, the event triggered by the AS is insensitive to the NAS and the size of MSG3 cannot meet the requirement on extension of UAC.

The technical solutions of the disclosure are further described below in combination with specific embodiments. The following solutions include two cases where a length of the MSG3 is extended and the length of the MSG3 is not extended. In this sense, the solutions are applicable to both eLTE and 5G NR. Additionally, in the case of not extending the length of the MSG3, the solutions are not limited to the eLTE, and may further be applicable to other types of communication systems such as LTE.

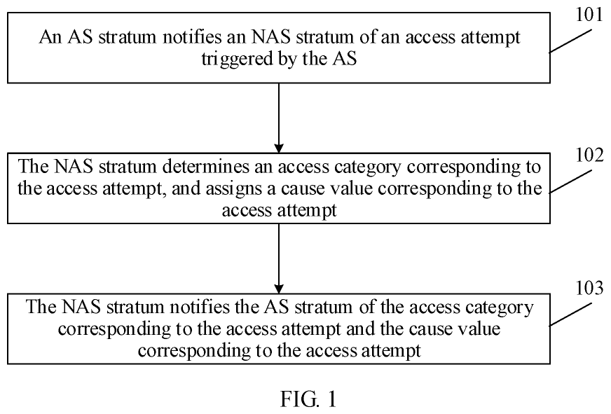

FIG. 1 is a first schematic flowchart of an ACB method according to embodiments of the disclosure. As shown in FIG. 1, the ACB method includes the following operations.

At operation 101: an AS stratum notifies an NAS stratum of an access attempt triggered by the AS.

After the AS stratum notifies the NAS stratum of the access attempt triggered by the AS, the NAS stratum can sense the access attempt triggered by the AS.

At operation 102: the NAS stratum determines an access category corresponding to the access attempt, and assigns a cause value corresponding to the access attempt.

Considering that the length (48 bits) of the MSG3 cannot meet the requirement on extension of the UAC, the following improvements are made in the embodiment of the disclosure.

Scenario 1: Extending a Length of MSG3:

The existing access category (for example, MO signaling) may be extended, and the NAS may define and set a new establishment cause (i.e., a cause value).

The NAS stratum may determine a first access category corresponding to the access attempt, and assign a first cause value corresponding to the first access category, the first cause value being a newly established cause value based on the first access category.

A length of a cause value field in the MSG3 may be extended to N bits, so as to store the cause value corresponding to the access attempt.

In an example: the length of the cause value field in the MSG3 can be extended to 4 bits (the original length is 3 bits), the cause value field may carry 16 types of cause values. 8 cause values can be carried additionally, compared with the original case.

In an implementation, the first access category may be an existing established access category. Only by extending the length of the cause value, new cause values can be carried.

In another implementation, the first access category may be a newly established access category. In such a case, one access category is newly added. The length of the cause value field in the MSG3 of the access category may be unchanged (i.e., the length is maintained at 3 bits), or may be extended to N bits (such as 4 bits). It should be understood that the cause value field correspondingly to the newly added access category may store all new cause values.

Scenario 2: Not Extending the MSG3:

For the case of not extending the MSG3, a new access category, such as AS-triggered MO signaling, may be defined, thus avoiding a problem that seven of eight establishment cause values in the existing MO signaling have been used. The re-defined access category (still in terms of the size of the MSG3) can also meet the requirement of AS-triggered events.

The NAS stratum may determine a second access category corresponding to the access attempt, and assign a second cause value corresponding to the second access category, the second access category being a newly established access category, and the second cause value being a cause value newly established based on the second access category.

The newly established access category may be implemented via the following manners:

The access category may be established newly among operator-defined access categories; or the access category may be established newly among standardized access categories.

The operator-defined access categories may include access category 32 to access category 63; and the standardized access categories may include access category 8 to access category 31.

Table 1 illustrates that the access category is newly established among the standardized access categories. The newly established access category can be respectively access category 8, access category 9 and access category 10:

TABLE 1

| Rule # | Type of access attempt | Requirement to be met | Access category | |
|---|---|---|---|---|
| 1 | Response to paging | Access attempt is for MT access | 0 | (=MT_acc) |
| 2 | Emergency | UE is attempting access for an | 2 | (=emergency) |
| | | emergency session (NOTE 1, | | |
| | | NOTE 2) | | |
| 3 | Access attempt for operator- | UE was provided with operator- | 32-63 (=based on operator | |
| | defined access category | defined access categories for the | classification) | |
| | | current PLMN, and access | | |
| | | attempt is matching criteria of an | | |
| | | operator-defined access category | | |
| 4 | Access attempt for delay | UE is configured for delay | 1 | (=delay tolerant) |
| | tolerant service | tolerant service, the PLMN is | | |
| | | broadcasting one of the categories | | |
| | | a, b or c, and the UE is a member | | |
| | | of the broadcasted category in the | | |
| | | selected PLMN or | | |
| | | RPLMN/equivalent PLMN | | |
| | | (NOTE 3) | | |
| 5 | MO MMTel voice call | Access attempt is for MO MMTel | 4 | (=MO MMTel voice) |
| | | voice call | | |
| | | or for NAS ignaling connection | | |
| | | recovery during ongoing MO | | |
| | | MMTel voice call (NOTE 2) | | |
| 6 | MO MMTel video call | Access attempt is for MO MMTel | 5 | (=MO MMTel video) |
| | | video call | | |
| | | or for NAS signaling connection | | |
| | | recovery during ongoing MO | | |
| | | MMTel video call (NOTE 2) | | |
| 7 | MO SMS over NAS or MO | Access attempt is for MO SMS or | 6 | (=MO SMS and SMSoIP) |
| | SMSoIP | SMSoIP transfer | | |
| | | or for NAS signaling connection | | |
| | | recovery during ongoing MO | | |
| | | SMS or SMSoIP transfer (NOTE | | |
| | | 2) | | |
| 8 | UE NAS initiated 5GMM | Access attempt is for MO | 3 | (=MO_sig) |
| | specific procedures | signaling | | |
| 9 | UE NAS initiated 5GMM | Access attempt is for MO data | 7 | (=MO_data) |
| | connection management | | | |
| | procedures or 5GMM NAS | | | |
| | transport procedure | | | |
| 10 | UE AS triggered specific | Access attempt is for MO | 8 | (=MO_sig_as1) |
| | procedure 1 | signaling triggered by AS layer, | | |
| | | i.e. RNAU | | |
| 11 | UE AS triggered specific | Access attempt is for MO | 9 | (=MO_sig_as2) |
| | procedure 2 | signaling triggered by AS layer, | | |
| | | i.e. PDU session setup | | |
| 12 | UE AS triggered specific | Access attempt is for MO | 10 | (=MO_sig_as3) |
| | procedure 3 | signaling triggered by AS layer | | |
| | | i.e. PDU session modify | | |

| | | | |
|---|---|---|---|
| . . . | . . . | . . . | . . . |

Table 2 illustrates that the access category is newly established among the operator-defined access categories. The newly established access category can be respectively access category 32, access category 33 and access category 34:

TABLE 2

| | Type of access | | | |
|---|---|---|---|---|
| Rule # | attempt | Requirement to be met | Access category | |
| 1 | Response to paging | Access attempt is for MT access | 0 | (=MT_acc) |
| 2 | Emergency | UE is attempting access for an | 2 | (=emergency) |
| | | emergency session (NOTE 1, NOTE | | |
| | | 2) | | |
| 3 | Access attempt for | UE was provided with operator- | 32-63 (=based on operator | |
| | operator-defined | defined access categories for the | classification) | |
| | access category | current PLMN, and access attempt is | | |
| | | matching criteria of an operator- | | |
| | | defined access category | | |
| | UE AS triggered | Access attempt is for MO signaling | 32 | (=MO_sig_as1) |
| | specific procedure 1 | triggered by AS layer, i.e. RNAU | | |
| | UE AS triggered | Access attempt is for MO signaling | 33 | (=MO_sig_as2) |
| | specific procedure 2 | triggered by AS layer, i.e. PDU | | |
| | | session setup | | |
| | UE AS triggered | Access attempt is for MO signaling | 34 | (=MO_sig_as3) |
| | specific procedure 3 | triggered by AS layer i.e. PDU | | |
| | | session modify | | |
| 6 | MO MMTel video | Access attempt is for MO MMTel | 5 | (=MO MMTel video) |
| | call | video call | | |
| | | or for NAS signaling connection | | |
| | | recovery during ongoing MO | | |
| | | MMTel video call (NOTE 2) | | |
| 7 | MO SMS over NAS | Access attempt is for MO SMS or | 6 | (=MO SMS and SMSoIP) |
| | or MO SMSoIP | SMSoIP transfer | | |
| | | or for NAS signaling connection | | |
| | | recovery during ongoing MO SMS | | |
| | | or SMSoIP transfer (NOTE 2) | | |
| 8 | UE NAS initiated | Access attempt is for MO signaling | 3 | (=MO_sig) |
| | 5GMM specific | | | |
| | procedures | | | |
| 9 | UE NAS initiated | Access attempt is for MO data | 7 | (=MO_data) |
| | 5GMM connection | | | |
| | management | | | |
| | procedures or | | | |
| | 5GMM NAS | | | |
| | transport procedure | | | |
| 10 | UE AS triggered | Access attempt is for MO signaling | 8 | (=MO_sig_as1) |
| | specific procedure 1 | triggered by AS layer, i.e. RNAU | | |
| 11 | UE AS triggered | Access attempt is for MO signaling | 9 | (=MO_sig_as2) |
| | specific procedure 2 | triggered by AS layer, i.e. PDU | | |
| | | session setup | | |
| 12 | UE AS triggered | Access attempt is for MO signaling | 10 | (=MO_sig_as3) |
| | specific procedure 3 | triggered by AS layer i.e. PDU | | |
| | | session modify | | |

| | | | |
|---|---|---|---|
| . . . | . . . | . . . | . . . |

The newly established access category may be merged with the existing access category in one table. As shown in Table 1 and Table 2, the newly added access category may also be stored in an independent table. In an application scenario, the existing access category stored in the table can be corresponding to an NAS-triggered event. The access category in the embodiments of the disclosure may be corresponding to an AS-triggered event and thus may be independently stored in a new table.

In the case of not extending the MSG3: the NAS stratum may determine a third access category corresponding to the access attempt, and assign a third cause value corresponding to the third access category, the third access category being an existing access category, and the third cause value being an existing cause value corresponding to the third access category.

It may be appropriate to not define a new access category or add a new cause value. The new AS-triggered access attempt may be mapped to the establishment cause of the existing access category.

At operation 103: the NAS stratum notifies the AS stratum of the access category corresponding to the access attempt and the cause value corresponding to the access attempt.

In this way, the AS stratum can trigger the ACB of the access attempt.

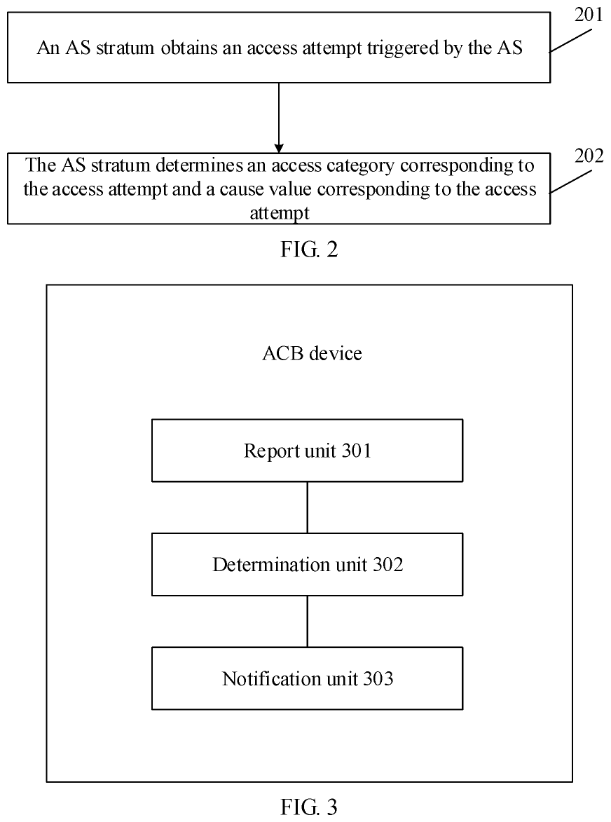

FIG. 2 is a second schematic flowchart of an ACB method according to embodiments of the disclosure. As shown in FIG. 2, the ACB method includes the following operations.

At operation 201: an AS stratum obtains an access attempt triggered by the AS.

At operation 202: the AS stratum determines an access category corresponding to the access attempt and a cause value corresponding to the access attempt.

Considering that the length (48 bits) of the MSG3 cannot meet the requirement on extension of the UAC, the following improvements are made in the embodiment of the disclosure.

Scenario 1: Extending a Length of MSG3:

The AS stratum may determine a first access category corresponding to the access attempt, and determine a first cause value corresponding to the first access category, the first cause value being a newly established cause value based on the first access category.

A length of a cause value field in the MSG3 may be extended to N bits, so as to store the cause value corresponding to the access attempt.

In an implementation, the first access category may be an existing established access category. Only by extending the length of the cause value, the new cause value can be carried.

In another implementation, the first access category may be a newly established access category. In such a case, one access category is newly added. The length of the cause value field in the MSG3 of the access category may be unchanged (i.e., the length is maintained at 3 bits), or may be extended to N bits (such as 4 bits). It should be understood that the cause value field correspondingly to the newly added access category may store all new cause values.

Scenario 2: Not Extending the MSG3:

The AS stratum may determine a second access category corresponding to the access attempt, and determine a second cause value corresponding to the second access category, the second access category being a newly established access category, and the second cause value being a cause value newly established based on the second access category.

The newly established access category may be implemented via the following manners:

the access category may be established newly among operator-defined access categories; or

the access category may be established newly among standardized access categories.

The operator-defined access categories may include access category 32 to access category 63; and the standardized access categories may include access category 8 to access category 31.

Upon determination of the access category and the cause value corresponding to the access attempt, the AS stratum can trigger the ACB of the access attempt.

The AS stratum may determine a third access category corresponding to the access attempt, and determine a third cause value corresponding to the third access category, the third access category being an existing access category, and the third cause value being an existing cause value corresponding to the third access category.

FIG. 3 is a first structural schematic diagram of an ACB device according to embodiments of the disclosure. As shown in FIG. 3, the ACB device includes: a report unit 301, a determination unit 302 and a notification unit 303.

The report unit 301 is configured to notify, via an AS stratum, an NAS stratum of an access attempt triggered by the AS.

The determination unit 302 is configured to determine, via an NAS stratum, an access category corresponding to the access attempt, and assign a cause value corresponding to the access attempt.

The notification unit 303 is configured to notify, via the NAS stratum, the AS stratum of the access category corresponding to the access attempt and the cause value corresponding to the access attempt.

In an implementation, in a case of extending a length of MSG3, the determination unit 302 is configured to determine, via the NAS stratum, a first access category corresponding to the access attempt, and assign a first cause value corresponding to the first access category, the first cause value being a newly established cause value based on the first access category.

In an implementation, the operation that a length of MSG3 is extended may include that:

a length of a cause value field in the MSG3 is extended to N bits, so as to store the cause value corresponding to the access attempt.

In an implementation, the first access category may be an existing established access category or a newly established access category.

In an implementation, in a case of not extending the MSG3, the determination unit 302 is configured to determine, via the NAS stratum, a second access category corresponding to the access attempt, and assign a second cause value corresponding to the second access category, the second access category being a newly established access category, and the second cause value being a cause value newly established based on the second access category.

In an implementation, the newly established access category may be implemented via the following manners:

the access category may be established newly among operator-defined access categories; or

the access category is established newly among standardized access categories.

In an implementation, the operator-defined access categories may include access category 32 to access category 63.

The standardized access categories may include access category 8 to access category 31.

In an implementation, in a case of not extending the length of the MSG3, the determination unit 302 is configured to determine, via the NAS stratum, a third access category corresponding to the access attempt, and assign a third cause value corresponding to the third access category, the third access category being an existing access category, and the third cause value being an existing cause value corresponding to the third access category.

Those skilled in the art should know that functions realized by each unit in the ACB device shown in FIG. 3 may be understood with reference to related descriptions about the ACB method. The functions of each unit in the ACB device shown in FIG. 3 may be realized through a program running in a processor, and may also be realized through a specific logical circuit.

FIG. 4 is a second structural schematic diagram of an ACB device according to embodiments of the disclosure. As shown in FIG. 4, the ACB device includes: an obtaining unit 401 and a determination unit 402.

The obtaining unit 401 is configured to obtain, via an AS stratum, an access attempt triggered by the AS.

The determination unit 402 is configured to determine, via the AS stratum, an access category corresponding to the access attempt and a cause value corresponding to the access attempt.

In an implementation, in a case of extending a length of MSG3, the determination unit 402 is configured to determine, via the AS stratum, a first access category corresponding to the access attempt, and determine a first cause value corresponding to the first access category, the first cause value being a newly established cause value based on the first access category.

In an implementation, the operation that a length of MSG3 is extended may include that:

a length of a cause value field in the MSG3 is extended to N bits, so as to store the cause value corresponding to the access attempt.

In an implementation, the first access category may be an existing established access category or a newly established access category.

In an implementation, in a case of not extending the MSG3, the determination unit 402 is configured to determine, via the AS stratum, a second access category corresponding to the access attempt, and determine a second cause value corresponding to the second access category, the second access category being a newly established access category, and the second cause value being a cause value newly established based on the second access category.

In an implementation, the newly established access category may be implemented via the following manners:

The access category may be established newly among operator-defined access categories; or

the access category may be established newly among standardized access categories.

In an implementation, the operator-defined access categories may include access category 32 to access category 63.

The standardized access categories may include access category 8 to access category 31.

In an implementation, in a case of not extending the length of the MSG3, the determination unit 402 is configured to determine, via the AS stratum, a third access category corresponding to the access attempt, and determine a third cause value corresponding to the third access category, the third access category being an existing access category, and the third cause value being an existing cause value corresponding to the third access category.

Those skilled in the art should know that functions realized by each unit in the ACB device shown in FIG. 4 may be understood with reference to related descriptions about the ACB method. The functions of each unit in the ACB device shown in FIG. 4 may be realized through a program running in a processor, and may also be realized through a specific logical circuit.

When being implemented in form of software functional module and sold or used as an independent product, the ACB device of the embodiments of the disclosure may also be stored in a computer-readable storage medium. Based on such an understanding, the technical solutions of the embodiments of the disclosure substantially or parts making contributions to the conventional art may be embodied as a software product, and the computer software product can be stored in a storage medium, including a plurality of instructions configured to enable a computer device (which may be a personal computer, a server, a network device or the like) to execute all or part of the method in each embodiment of the disclosure. The storage medium may include: various media capable of storing program codes, such as a U disk, a mobile hard disk, a Read Only Memory (ROM), a magnetic disk or an optical disk. Therefore, the embodiments of the disclosure are not limited to any specific hardware and software combination.

Correspondingly, an embodiment of the disclosure further provides a computer storage medium, which has computer executable instructions stored thereon. The computer executable instructions may be executed by a processor to implement the above-mentioned ACB methods.

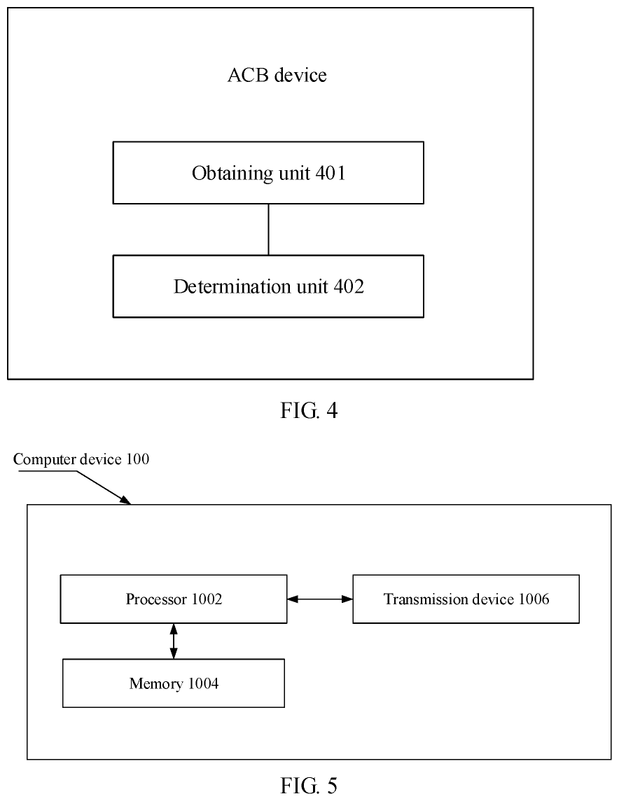

FIG. 5 is a structural schematic diagram of a computer device according to embodiments of the disclosure. The computer device may be any type of terminal. As shown in FIG. 5, the computer device 100 may include one or more (only one is illustrated in the figure) processors 1002 (the processor 1002 may include, but is not limited to, a processing device such as a Micro Control Unit (MCU) or a Field Programmable Gate Array (FPGA)), a memory 1004 configured to store data and a transmission device 1006 configured for a communication function. Those of ordinary skill in the art should know that the structure shown in FIG. 5 is only schematic and not intended to limit the structure of the electronic device. In an example, the computer device 100 may further include components more or fewer than the components shown in FIG. 5 or has a configuration different from that shown in FIG. 5.

The memory 1004 may be configured to store a software program of application software and a module, for example, program instructions/modules corresponding to the methods in the embodiments of the disclosure. The processor 1002 can run the software program and module stored in the memory 1004, thereby executing various functional applications and data processing, namely implementing the above-mentioned methods. The memory 1004 may include a high-speed random access memory and may also include a nonvolatile memory, for example, one or more magnetic storage devices, flash memories or other nonvolatile solid-state memories. In some examples, the memory 1004 may further include a memory arranged remotely relative to the processor 1002 and the remote memory may be connected to the computer device 100 through a network. An example of the network includes, but not limited to, the Internet, an intranet, a local area network, a mobile communication network and a combination thereof.

The transmission device 1006 is configured to receive or send data through a network. A specific example of the network may include a wireless network provided by a communication provider of the computer device 100. In an example, the transmission device 1006 may include a network interface controller (NIC), which may be connected with another network device through a base station, thereby communicating with the Internet. In an example, the transmission device 1006 may be a radio frequency (RF) module, configured to communicate with the Internet in a wireless manner.

In the technical solutions of the embodiments of the disclosure, an AS stratum may notify an NAS stratum of an access attempt triggered by the AS; the NAS stratum may determine an access category corresponding to the access attempt, and assigns a cause value corresponding to the access attempt; and the NAS stratum may notify the AS stratum of the access category corresponding to the access attempt and the cause value corresponding to the access attempt. An AS stratum may obtain an access attempt triggered by the AS; and the AS stratum may determine an access category corresponding to the access attempt and a cause value corresponding to the access attempt. Further, a length of MSG3 may be extended to carry a new cause value; or, a new access category may be established to carry the new cause value. By adopting the technical solutions of the embodiments of the disclosure, ACB of the access attempt triggered by the AS can be supported via a UAC mechanism in eLTE and NR.

The technical solutions recorded in the embodiments of the disclosure may be freely combined without conflicts.

In some embodiments provided by the disclosure, it is to be understood that the method and intelligent device may be implemented in another manner. The device embodiments described above are only schematic. In an example, division of the units is only logic function division, and other division manners may be adopted during practical implementation. In an example, multiple units or components may be combined or integrated into another system, or some characteristics may be neglected or not executed. In addition, coupling or direct coupling or communication connection between each displayed or discussed component may be indirect coupling or communication connection, implemented through some interfaces, of the device or the units, and may be electrical and mechanical or adopt other forms.

The units described as separate parts may be or may not be physically separated, and parts displayed as units may or may not be physical units, and namely may be located in the same place, or may also be distributed to multiple network units. Part of all of the units may be selected according to a practical requirement to achieve the purposes of the solutions of the embodiments.

In addition, each functional unit in each embodiment of the disclosure may be integrated into a second processing unit, each unit may also serve as an independent unit and two or more than two units may also be integrated into a unit. The integrated unit may be implemented in a hardware form and may also be implemented in form of hardware and software functional unit.

The above are only the specific implementation manners of the disclosure and not intended to limit the scope of protection of the disclosure. Any variations or replacements apparent to those skilled in the art within the technical scope disclosed by the disclosure shall fall within the scope of protection of the disclosure.

1. A method for access control barring, comprising:
notifying, by an access stratum (AS), a non-access stratum (NAS) of an access attempt triggered by the AS;
determining, by the NAS stratum, an access category corresponding to the access attempt, and assigning a cause value corresponding to the access attempt; and
notifying, by the NAS stratum, the AS stratum of the access category and the cause value corresponding to the access attempt.

2. The method of claim 1, wherein in a case of extending a length of message 3 (MSG3), the determining, by the NAS stratum, an access category corresponding to the access attempt, and assigning a cause value corresponding to the access attempt comprises:
determining, by the NAS stratum, a first access category corresponding to the access attempt, and assigning a first cause value corresponding to the first access category, the first cause value being a newly established cause value based on the first access category.

3. The method of claim 2, wherein the extending a length of MSG3 comprises:
extending a length of a cause value field in the MSG3 to N bits, so as to store the cause value corresponding to the access attempt.

4. The method of claim 1, wherein in a case of not extending a length of MSG3, the determining, by the NAS stratum, an access category corresponding to the access attempt, and assigning a cause value corresponding to the access attempt comprises:
determining, by the NAS stratum, a second access category corresponding to the access attempt, and assigning a second cause value corresponding to the second access category, the second access category being a newly established access category, and the second cause value being a cause value newly established based on the second access category; or
determining, by the NAS stratum, a third access category corresponding to the access attempt, and assigning a third cause value corresponding to the third access category, the third access category being an existing access category, and the third cause value being an existing cause value corresponding to the third access category.

5. A method for access control barring, comprising:
obtaining, by an access stratum (AS), an access attempt triggered by the AS; and
determining, by the AS stratum, an access category corresponding to the access attempt and a cause value corresponding to the access attempt.

6. The method of claim 5, wherein in a case of extending a length of message 3 (MSG3), the determining, by the AS stratum, an access category corresponding to the access attempt and a cause value corresponding to the access attempt comprises:
determining, by the AS stratum, a first access category corresponding to the access attempt, and determining a first cause value corresponding to the first access category, the first cause value being a newly established cause value based on the first access category.

7. The method of claim 6, wherein the extending a length of MSG3 comprises:
extending a length of a cause value field in the MSG3 to N bits, so as to store the cause value corresponding to the access attempt.

8. The method of claim 6, wherein the first access category is an existing established access category or a newly established access category.

9. The method of claim 5, wherein in a case of not extending a length of MSG3, the determining, by the AS stratum, an access category corresponding to the access attempt and a cause value corresponding to the access attempt comprises:
determining, by the AS stratum, a second access category corresponding to the access attempt, and determining a second cause value corresponding to the second access category, the second access category being a newly established access category, and the second cause value being a cause value newly established based on the second access category.

10. The method of claim 8, wherein the newly established access category is implemented via following manners:
newly establishing the access category among operator-defined access categories; or
newly establishing the access category among standardized access categories.

11. The method of claim 10, wherein
the operator-defined access categories comprise access category 32 to access category 63; and
the standardized access categories comprise access category 8 to access category 31.

12. The method of claim 5, wherein in a case of not extending a length of MSG3, the determining, by the AS stratum, an access category corresponding to the access attempt and a cause value corresponding to the access attempt comprises:
determining, by the AS stratum, a third access category corresponding to the access attempt, and determining a third cause value corresponding to the third access category, the third access category being an existing access category, and the third cause value being an existing cause value corresponding to the third access category.

13. A device for access control barring, comprising:
a processor,
a memory, configured to store instructions executable by the processor, and
a transmission device, configured to receive or send data,
wherein the processor is configured to:
control the transmission device to obtain, via an access stratum (AS), an access attempt triggered by the AS; and
determine an access category corresponding to the access attempt and a cause value corresponding to the access attempt.

14. The device of claim 13, wherein in a case of extending a length of message 3 (MSG3), the processor is configured to determine, via the AS stratum, a first access category corresponding to the access attempt and determine a first cause value corresponding to the first access category, the first cause value being a newly established cause value based on the first access category.

15. The device of claim 14, wherein the extending a length of MSG3 comprises:
extending a length of a cause value field in the MSG3 to N bits, so as to store the cause value corresponding to the access attempt.

16. The device of claim 14, wherein the first access category is an existing established access category or a newly established access category.

17. The device of claim 13, wherein in a case of not extending a length of MSG3, the processor is configured to:
determine, via the AS stratum, a second access category corresponding to the access attempt and determine a second cause value corresponding to the second access category, where the second access category is a newly established access category, and the second cause value is a cause value newly established based on the second access category.

18. The device of claim 16, wherein the newly established access category is implemented via following manners:
newly establishing the access category among operator-defined access categories; or
newly establishing the access category among standardized access categories.

19. The device of claim 18, wherein
the operator-defined access categories comprise access category 32 to access category 63; and
the standardized access categories comprise access category 8 to access category 31.

20. The device of claim 13, wherein in a case of not extending a length of MSG3, the determination unit is configured to determine, via the AS stratum, a third access category corresponding to the access attempt and determine a third cause value corresponding to the third access category, where the third access category is an existing access category, and the third cause value is an existing cause value corresponding to the third access category.
